(19) United States
(12) Patent Application Publication
(10) Pub. No.: US 2025/0148150 A1
(43) Pub. Date: May 8, 2025

(54) SYSTEM AND METHOD TO ESTIMATE TIRE NOISE

(71) Applicants: The Goodyear Tire & Rubber Company, Akron, OH (US); National Technology & Engineering Solutions of Sandia, LLC, Albuquerque (NM)

(72) Inventors: Mohammad Sobhanie, Akron, OH (US); Padmarajaiah Saligrama Karidevaiah, Copley, OH (US); Tyler Voskuilen, Albuquerque, NM (US); Tim Walsh; Nathan Crane, Albuquerque, NM (US)

(21) Appl. No.: 18/883,450

(22) Filed: Sep. 12, 2024

Related U.S. Application Data
(60) Provisional application No. 63/597,136, filed on Nov. 8, 2023.

(51) Int. Cl. G06F 30/15; G06F 30/23; G06F 119/10

(52) U.S. Cl. CPC G06F 30/15; G06F 30/23; G06F 2119/10

(57) ABSTRACT

A plurality of air flow velocity vectors are generated at a plurality of predefined angles of rotation of a digital model of a rotating tire. Individual ones of the vectors are associated with a corresponding one of a plurality of first cells of a first mesh with a tread of the rotating tire or a corresponding one of a plurality of second cells of a second mesh in a volume around the rotating tire. Air flow velocity vectors are converted into corresponding ones of a plurality of Lighthill stress tensors. An acoustic pressure is generated at a plurality of points on a surface of the volume for each of the predefined angles of rotation of the rotating tire based on the Lighthill stress tensors. An estimate of a magnitude of sound generated by the rotating tire is determined from the acoustic pressure at a respective one of the points.

### STATEMENT OF GOVERNMENT INTEREST

This invention was made with United States Government support under Contract No. DE-NA0003525 between National Technology & Engineering Solutions of Sandia, LLC and the United States Department of Energy. The United States Government has certain rights in this invention.

### BACKGROUND

Tires for vehicles come with treads that vary significantly. Various treads are created for various purposes. The noise that a tire makes while a vehicle travels on a roadway can be significant. In urban areas and areas near highways, such noise can be pervasive.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a schematic of a networked environment that includes a computing environment upon which tire noise analysis is performed according to various embodiments of the present disclosure.

FIG. 2 is a drawing of an example of a digital model of a rotating tire that is the subject of the tire noise analysis performed on the computing environment in FIG. 1 according to various embodiments of the present disclosure.

FIG. 3 is a drawing of an example of a mesh that is used in the tire noise analysis performed on the computing environment in FIG. 1 according to various embodiments of the present disclosure.

FIG. 4 is a drawing of an example of a volume around the digital model of the rotating tire of FIG. 2 according to various embodiments of the present disclosure.

FIG. 5 is a top view of the volume around the digital model of the rotating tire of FIG. 4 according to various embodiments of the present disclosure.

FIG. 6 is a flow chart that depicts one example of a tire noise analysis system that is executed on the computing environment in FIG. 1 according to various embodiments of the present disclosure.

FIGS. 7A and 7B are flow charts that depict subsystems of the tire noise analysis system of FIG. 6 according to various embodiments of the present disclosure.

### DETAILED DESCRIPTION

Disclosed herein are various examples related to non-destructive examination of tires using radar tomography. Reference will now be made in detail to the description of the embodiments as illustrated in the drawings, wherein like reference numbers indicate like parts throughout the several views.

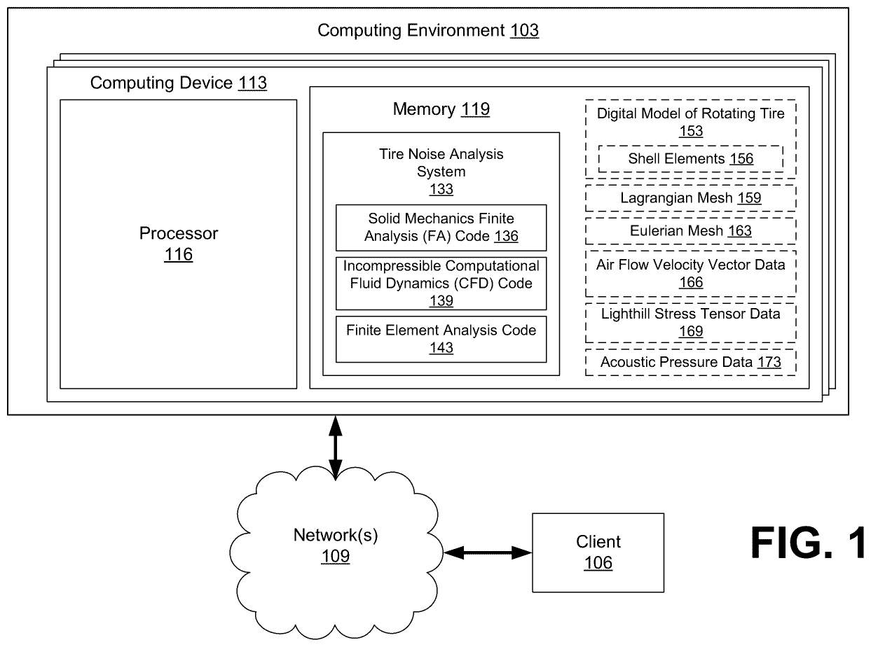

With reference to FIG. 1, shown is a networked environment 100 according to various embodiments. The networked environment 100 includes a computing environment 103 and a client 106 that are in data communication with each other via a network 109. The network 109 comprises, for example, the Internet, intranets, extranets, wide area networks (WANs), local area networks (LANs), wired networks, wireless networks, or other suitable networks, etc., or any combination of two or more such networks. For example, such networks may comprise satellite networks, cable networks, Ethernet networks, and other types of networks.

The computing environment 103 may comprise, for example, a computing device 113 such as, for example, a server computer or any other system providing computing capability. Alternatively, the computing environment 103 may employ a plurality of computing devices 113 such as servers that may be arranged, for example, in one or more server banks or computer banks or other arrangements. Such computing devices may be located in a single installation or may be distributed among many different geographical locations. For example, the computing environment 103 may include a plurality of computing devices 113 that together may comprise a hosted computing resource, a grid computing resource and/or any other distributed computing arrangement. In some cases, the computing environment 103 may correspond to an elastic computing resource where the allotted capacity of processing, network, storage, or other computing-related resources may vary over time.

Each computing device 113 may include one or more processor circuits including a processor 116 and associated memory 119. The memory 119 is defined herein as including both volatile and nonvolatile memory and data storage components. Volatile components are those that do not retain data values upon loss of power. Nonvolatile components are those that retain data upon a loss of power. Thus, the memory 119 may comprise, for example, random access memory (RAM), read-only memory (ROM), hard disk drives, solid-state drives, USB flash drives, memory cards, and/or other memory components, or a combination of any two or more of these memory components.

The client 106 is representative of a plurality of client devices that may be coupled to the network 109. The client 106 may comprise, for example, a processor-based system such as a computer system. Such a computer system may be embodied in the form of a desktop computer, a laptop computer, tablet computer, or other device. The client 106 may be configured to execute various applications such as a proprietary application, browser, and/or other applications to interact with the tire noise analysis system 133.

Various applications and/or other functionality may be executed in the computing environment 103 according to various embodiments. Also, various data is stored in the memory 119 that is accessible to the applications executed in the computing environment 103. The data stored in the memory 119, for example, is associated with the operation of the various applications and/or functional entities described below.

The applications that are stored in the memory 119 and are executable by one or more processors 116 of various computing devices 113 include a tire noise analysis system 133. The tire noise analysis system 133 includes subsystems such as, for example, solid mechanics finite analysis code 136, incompressible computational fluid dynamics code 139, finite element analysis code 143, and potentially other subsystems and components.

In addition, data is stored in the memory 119 in association with the operation of the tire noise analysis system 133. The data stored in the memory 119 includes a digital model of a rotating tire 153 that includes shell elements 156. Further data stored in the memory 119 include a Lagrangian mesh 159, an Eulerian mesh 163, air flow velocity vector data 166, Lighthill stress tensor data 169, acoustic pressure data 173, and potentially other data.

The tire noise analysis system 133 is executed to generate an estimate of the airborne noise created by a given tread pattern of a tire. The sources of noise of a rotating tire include air pumping, tire vibration, and aeroacoustics. In executing the tire noise analysis system 133 various subsystems are executed as will be described.

The solid mechanics finite analysis code 136 is executed as part of the tire noise analysis system 133 in order to generate the digital model of a rotating tire 153. The digital model of the rotating tire 153 includes a tread that is under evaluation. In generating an estimate of the airborne noise created by a given tread, certain shell elements are added to the digital model of the rotating tire 153 for further analysis as will be described. In one embodiment, the solid mechanics finite analysis code 136 comprises a Presto algorithm created by the Sandia National Laboratory located in Albuquerque, New Mexico.

The Lagrangian mesh 159 is specified in the grooves and sipes of the tread of the digital model of the rotating tire 153. The Lagrangian mesh 159 includes a large number of cells for which the movement of air in the grooves and sipes of the tread is determined. According to one embodiment, there may be approximately 100,000,000 cells specified in the grooves and sipes of a given tread, although the number of cells specified may be greater than or less than this value.

In addition, an Eulerian mesh 163 is specified in a volume around the digital model of the rotating tire 153. In one embodiment, the volume is in the shape of a dome that surrounds the digital model of the rotating tire 153 as will be discussed. According to one embodiment, the number of cells specified in the volume that surrounds the digital model of the rotating tire 153 may be approximately 50,000,000, although the number of cells specified may be greater or less than this number.

The shell elements 156 define a boundary between the Lagrangian mesh 159 and the Eulerian mesh 163 as will be described.

The incompressible computational fluid dynamics (CFD) code 139 is executed as part of the tire noise analysis system 133 in order to generate the air flow velocity vector data 166 based on the digital model of the rotating tire 153 with the shell elements 156. The air flow velocity vector data 166 includes an air flow velocity vector for each cell of the Lagrangian mesh 159 and the Eulerian mesh 163. The air flow velocity vector data 166 is generated for a plurality of angles of rotation of the digital model of the rotating tire 153 as will be described.

The tire noise analysis system 133 is further executed to generate the Lighthill stress tensor data 169 from the air flow velocity vector data 166 for each angle of rotation of the digital model of the rotating tire 153. The Lighthill stress tensor data 169 comprises a Lighthill stress tensor for each corresponding air flow velocity vector in the air flow velocity vector data 166. Each Lighthill stress tensor comprises a scalar value as can be appreciated.

The finite element analysis code 143 is executed by the tire noise analysis system 133 to convert the Lighthill stress tensor data 169 to acoustic pressure data 173. An estimate of the airborne noise created by the tread pattern of the digital model of the rotating tire 153 is obtained from the acoustic pressure data 173 determined at specific angles of rotation of the rotating tire 153.

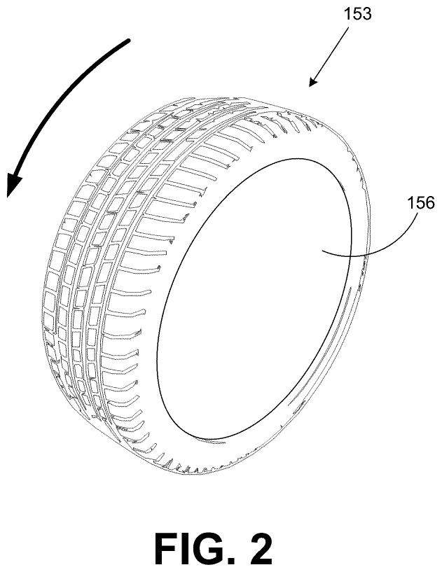

With reference to FIG. 2, shown is an example of the digital model of the rotating tire 153 according to one embodiment of the present disclosure. The digital model of the rotating tire 153 includes a shell element 156 that covers the area where a hubcap would exist. In addition, a further shell element 156 is positioned on the outer surface of the tread to provide for a boundary between the Lagrangian mesh 159 and the Eulerian mesh 163.

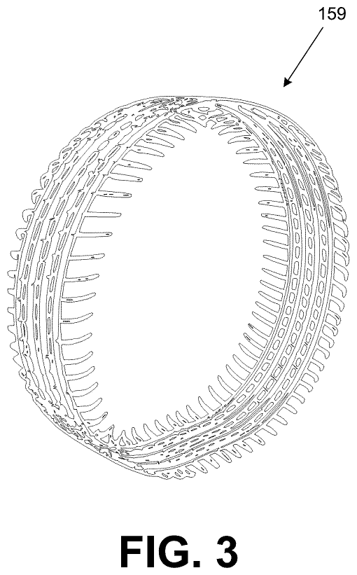

Referring next to FIG. 3, shown is an example of a Lagrangian mesh 159 according to an embodiment of the present disclosure. The Lagrangian mesh 159 comprises a volume dictated by the shape of the grooves and sipes of the tread of the digital model of the rotating tire 153. The Lagrangian mesh 159 may comprise a relatively large number of cells as is needed for analysis. In one embodiment, the number of cells may be approximately 100,000,000, although another number may be specified. In one embodiment, an example sipe in a tire tread may be approximately 0.7 mm wide. A cell may extend along the entire width of the sipe and may be approximately 0.5 mm long in the longitudinal direction of the sipe. Cell sizes may vary where, in one embodiment, the longitudinal size of a given cell may be within the range of approximately 0.5 mm to 1.0 mm. In one embodiment, 3 to 4 cells may be specified across a given groove in a tread where the groove is wider than the sipes of the tread. Also, in one embodiment at least three cells are specified through the width of sipes in the Lagrangian mesh 159.

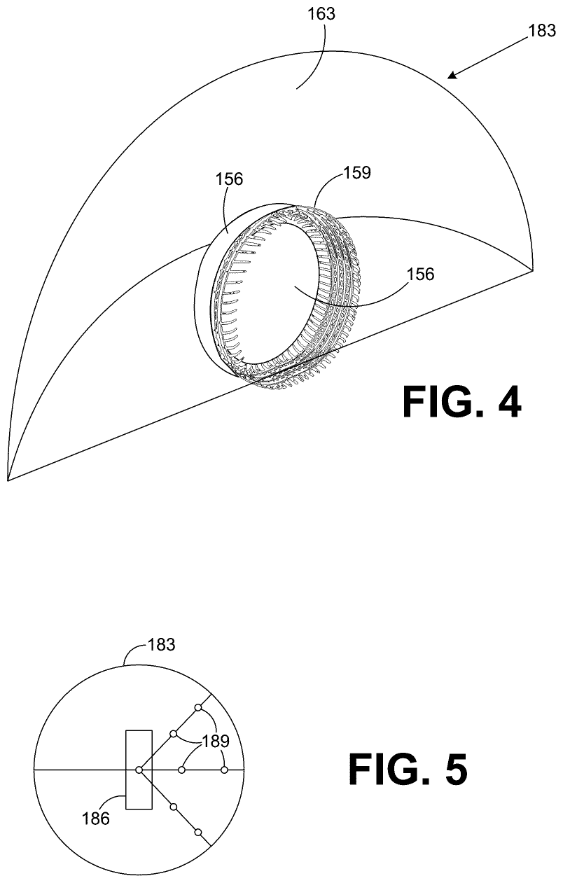

With reference to FIG. 4, shown is an example of the volume 183 that surrounds the Lagrangian mesh 159 with the shell elements 156. The shell element 156 that covers the tread is only shown partially, where half of the volume 183 is shown. In one embodiment, the volume 183 comprises a dome with a radius of approximately 1 meter, although the dome may be larger or smaller than this benchmark. The Eulerian mesh 163 is specified in the volume of the dome from the boundary specified by the exposed surfaces of the tire and the shell elements 156. In one embodiment, the Eulerian mesh 163 may include, for example, 50,000,000 cells or other number of cells.

With reference to FIG. 5, shown is an example of a top view of the volume 183 according to one embodiment. In the example of FIG. 5, the volume 183 is a dome. A tire 186 is positioned in the middle of the volume 183. In addition, multiple microphone positions 189 are located on a surface of the volume 183. The microphone positions 189 are specified for the placement of microphones near a tire during a test to determine the actual magnitude of the tire noise. The estimate of airborne noise due to a tread of a tire that is generated by the tire noise analysis system 133 may obtain an estimate of noise at the predefined microphone positions 189 if desired as will be described.

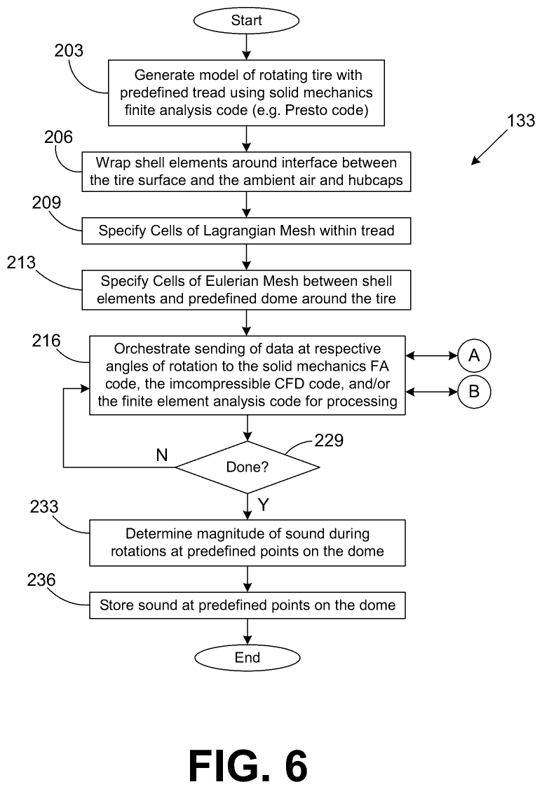

Turning next to FIG. 6, shown is a flowchart that provides one example of the operation of a portion of the tire noise analysis system 133 according to various embodiments. It is understood that the flowchart of FIG. 6 provides merely an example of the many different types of functional arrangements that may be employed to implement the functionality as described herein. As an alternative, the flowchart of FIG. 6 may be viewed as depicting an example of elements of a method implemented in the computing environment 103 (FIG. 1) according to one or more embodiments.

In addition, although the flowchart of FIG. 6 shows a specific order of execution, it is understood that the order of execution may differ from that which is depicted. For example, the order of execution of two or more blocks may be scrambled relative to the order shown. Also, two or more blocks shown in succession in FIG. 6 may be executed concurrently or with partial concurrence. Further, in some embodiments, one or more of the blocks shown in FIG. 6 may be skipped or omitted.

In addition, given the significant number of cells in the Lagrangian mesh 159 (FIG. 1) and the Eulerian mesh 163 (FIG. 1), the processing performed by the various subsystems of the tire noise analysis system 133 may operate on batches of data as will be described.

With specific reference to FIG. 6, beginning with box 203, the tire noise analysis system 133 generates the digital model of the rotating tire 153 (FIG. 1) and stores the same in the memory 119 (FIG. 1). The rotating tire 153 is specified to include a predefined tread. In order to generate the digital model of the rotating tire 153, the solid mechanics finite analysis (FA) code 136 (FIG. 1) may be employed. To this end, a model of the tire is provided as an input to the solid mechanics FA code 136 to perform a solid mechanics finite analysis. In the digital model of the rotating tire 153, the tire is rotated in angular increments that will provide for adequate data such that an ultimate estimate of tire noise is meaningful. In one embodiment, the digital model of the rotating tire 153 includes angular increments of three one hundredths ( 3/100) of degree although some other angular increment may be specified. In one embodiment, the digital model of the rotating tire 153 encompasses two full rotations of a tire, although any number of rotations may be specified taking into account the relatively large amount of data that is generated and computing capacity that would be needed for performing further analysis as will be described below. Also, the digital model of the rotating tire 153 is generated at a predefined speed of rotation that is selected, for example, to be a common speed that is experienced that approximates an average maximum amount of noise. In one embodiment, the speed is set at 80 kilometers per hour, although other speeds may be specified.

In one embodiment, the solid mechanics FA code 136 that performs the solid mechanics finite analysis comprises a Presto code that was generated at the Sandia National Laboratory located in Albuquerque, New Mexico.

Next, in box 206, the shell elements 156 (FIG. 1) are added to the digital model of the rotating tire 153. As mentioned above, the shell elements 156 provide for a boundary between the Lagrangian mesh 159 (FIG. 1) and the Eulerian mesh 163 (FIG. 1). In one embodiment, a shell element 156 is positioned in the center of the rotating tire where a hubcap structure would exist. Also, a second shell element 156 is positioned on a surface of the tire that comes into contact with the ground covering the tread.

In box 209, the cells of the Lagrangian mesh 159 are specified within the predefined tread of the tire as discussed above.

In box 213, the cells of the Eulerian mesh 163 are specified in the volume around the tire. In one embodiment, the volume exists between the boundaries provided by the shell elements 156 and exposed surface areas of the tire and an outer shell of the volume itself. In one embodiment, the volume is specified to be a dome including a 1 meter radius that is positioned around the tire. The number of cells in the Eulerian mesh 163 are specified so as to provide for a meaningful estimate of the noise generated by a tire including a predefined tread design. In one embodiment, the Eulerian mesh 163 may include over 50,000,000 cells, although the actual number of cells may vary significantly.

Next, in box 216, the tire noise analysis system 133 orchestrates the sending of data at respective angles of rotation to subsystems including the incompressible CFD code 139 and the finite element analysis code 143 in order to perform detailed processing to generate an estimate of tire noise. In this respect, an angular increment may be specified where processing by the above three subsystems is performed on the data from each angle of rotation based on the angular increment. In one embodiment, the angular increment is 5 degrees, although some other increment may be specified. As such, further analysis is performed at rotational angles of 5°, 10°, 15°, and so on. Given the fact that the processing to be performed by the incompressible CFD code 139 and the finite element analysis code 143 are computationally intensive, the actual angular increment is specified so as to provide meaningful results, but at the same time keep the computational load at a manageable level that does not take an unacceptable amount of time to implement.

In order to orchestrate the sending of data to the incompressible CFD code 139 and the finite element analysis code 143, the tire noise analysis system 133 sends data associated with consecutive angular increments to respective ones of these subsystems at the same time to facilitate faster processing as noted by connectors A and B. Specifically, if data from an angular increment was sent to the incompressible CFD code 139 at time t, then the results of the previous angular increment processed by the incompressible CFD code 139 at time t−1 is sent to the finite element analysis code 143 through connectors A and B. As such, parallel processing is facilitated.

As mentioned above, the computational load presented by the processing of the incompressible CFD code 139 and the finite element analysis code 143 is very large given that the Lagrangian mesh 159 and the Eulerian mesh 163 have at least tens of millions, if not hundreds of millions of cells. In one embodiment the computing environment 103 specified to implement the tire noise analysis system 133 including the solid mechanics FA code 136, the incompressible CFD code 139, and the finite element analysis code 143 includes 1400 processor circuits or CPUs, where total processing time took between 3 to 5 days. However, it is understood that the number of processor circuits may differ from 1400, and the time for total processing may take less than 3 days or more than 5 days depending on resources allocated as can be appreciated.

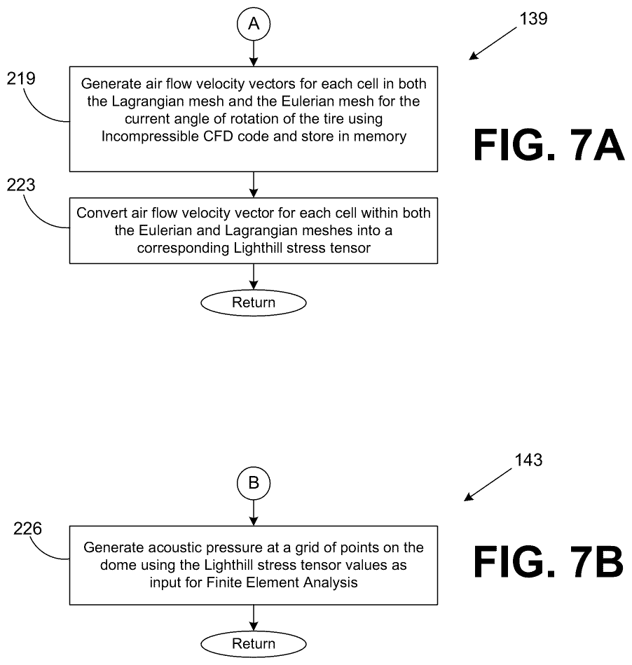

Referring next to FIG. 7A, the incompressible CFD code 139 is called through connector A to further process the data for a given angular increment of the rotating tire 153 (FIG. 1). In box 219, the incompressible CFD code is a subsystem that generates air flow velocity vectors for each of the cells in the Lagrangian mesh 159 and the Eulerian mesh 163 for the respective angle of rotation of the digital model of the rotating tire 153. The air flow velocity vectors generated are stored in the memory 119 in association with a respective one of the cells in the Lagrangian mesh 159 or the Eulerian mesh 163. In this respect, each individual one of the air flow velocity vectors is associated with a corresponding one of the cells in either the Lagrangian mesh 159 or the Eulerian mesh 163. In one embodiment, the incompressible CFD code 139 comprises a Fuego code that was generated at the Sandia National Laboratory located in Albuquerque, New Mexico.

Next, in box 223 the air flow velocity vector for each cell within both the Lagrangian mesh 159 and the Eulerian mesh 163 are converted into a corresponding Lighthill stress tensor, which comprises a scalar value that is stored as the Lighthill stress tensor data 169. The Lighthill stress tensors are mapped from the respective cell of the Lagrangian mesh 159 or the Eulerian mesh 163 to corresponding cells in acoustic meshes used to store the Lighthill stress tensors themselves. In calculating the Lighthill stress tensors, the following equation is employed:

$$\frac{1 {\partial }^{2} p}{{c}^{2} {\partial }^{2} t} - {∇}^{2} p = {ρ}_{0} \frac{{\partial }^{2} {T}_{ij}}{\partial {x}_{i} \partial {x}_{j}} \qquad ( Equation 1 )$$

where p is the acoustic pressure, c is the speed of sound, t is time, Tᵢⱼ is the incompressible form of the Lighthill stress tensor, and xᵢ and xⱼ are cartesian coordinates.

Note that the incompressible form of the Lighthill stress tensor Tᵢⱼ is given by

$${T}_{ij} = ρ {μ}_{i} {μ}_{j} - {τ}_{ij} , \qquad ( Equation 2 )$$

Where ρμᵢμⱼ is inertia and τᵢⱼ is the viscous stress. To calculate the Lighthill stress tensor, the incompressible CFD code 139 calculates the right hand side of Equation 2. Once the Lighthill stress tensor data 169 has been generated for the current angular increment of the digital model of the rotating tire 153, the execution returns to box 216 where the data associated with the next angular increment is provided for processing if any is left to be processed.

With reference to FIG. 7B, finite element analysis code 143 is called through connector B to further process the data for a given angular increment of the rotating tire 153 (FIG. 1). In box 226, an acoustic pressure value is generated for each one of a plurality of points on the surface of the volume 183 (FIG. 4). In doing so, finite element analysis code 142 accesses the Lighthill stress tensor values of the acoustic meshes as input to generate an acoustic pressure at a plurality of points on a surface of the volume 183. The acoustic pressure values are stored in the memory 119 (FIG. 1). The finite element analysis code 143 may comprise, for example, a Salinas code that was generated at the Sandia National Laboratory located in Albuquerque, New Mexico. Once the acoustic pressure values are stored in the memory 119, the execution returns to box 216 where the data associated with the next angular increment is provided for processing if any is left to be processed.

Referring back to FIG. 6, in box 229 it is determined if all of the calculations performed in boxes 219 (FIG. 7), 223 (FIG. 7), and 226 (FIG. 7) have been performed on the last angle of rotation to be considered. According to one embodiment, the angular increment at which the calculations in boxes 219, 223, and 226 are performed is 0.05 degrees. Assuming that the digital model of the rotating tire 153 includes data from two full rotations of a tire, then there will be 14,400 total angles of rotation for which calculations are to be performed. It is understood that the angular increment may be specified as a value other than 0.05 degrees.

If in box 229 the last angle of rotation has been processed by the finite element analysis code 143 (FIG. 1), the tire noise analysis system 133 proceeds to box 233. Otherwise, the tire noise analysis system 133 continues to orchestrate the processing at box 216.

In box 233, an estimate of the magnitude of sound generated by the tread of the tire depicted in the digital model of the rotating tire 153 is generated. According to one embodiment, the estimate of sound is generated by aggregating the magnitude of sound data from multiple angular increments calculated at respective points on the surface of the volume 183 such as the dome. In one embodiment, the magnitude of sound is determined at the predefined microphone positions 189 (FIG. 5).

Thereafter, in box 236 the sound determined at the respective points on the surface of the volume 183 such as at the predefined microphone positions 189 is stored in the memory 119. Such data may be accessed and rendered in suitable graphs or other form of output to indicate an estimate of tire noise by a tire constructed using a design set forth in the digital model of the rotating tire 153. Thereafter, the execution of the tire noise analysis system 133 ends as shown.

In the present disclosure, disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. An apparatus, comprising:
a digital model of a rotating tire stored in a memory, the rotating tire including a predefined tread;
a plurality of first cells of a first mesh within the predefined tread stored in the memory;
a plurality of second cells of a second mesh in a volume around the rotating tire stored in the memory;
at least one processor circuit executing instructions stored in the memory, the instructions causing the at least one processor circuit to at least:
generate a plurality of air flow velocity vectors at a plurality of predefined angles of rotation of the rotating tire, where individual ones of the air flow velocity vectors are associated with a corresponding one of the first or second cells;
convert the air flow velocity vectors into corresponding ones of a plurality of Lighthill stress tensors;
generate an acoustic pressure at a plurality of points on a surface of the volume for each of the predefined angles of rotation of the rotating tire based on the Lighthill stress tensors; and
determine an estimate of a magnitude of sound generated by the rotating tire.

2. The apparatus of claim 1, wherein the first mesh further comprises a Lagrangian mesh.

3. The apparatus of claim 1, wherein the second mesh further comprises a Eulerian mesh.

4. The apparatus of claim 1, wherein the instructions further cause the at least one processor circuit to generate the digital model of the rotating tire and store the digital model of the rotating tire in the memory.

5. The apparatus of claim 4, wherein the generation of the digital model of the rotating tire further comprises performing a solid mechanics finite analysis.

6. The apparatus of claim 5, wherein the solid mechanics finite analysis is performed using a Presto subsystem.

7. The apparatus of claim 1, wherein the generation of the plurality of air flow velocity vectors at the plurality of predefined angles of rotation of the rotating tire further comprises:
generating the plurality of air flow velocity vectors using an incompressible computational fluid dynamics subsystem; and
storing the plurality of air flow velocity vectors in the memory.

8. The apparatus of claim 1, wherein the generation of the acoustic pressure at the plurality of points on the surface of the volume for each of the predefined angles of rotation of the rotating tire further comprises:
performing a finite element analysis using the Lighthill stress tensors as an input to generate an acoustic pressure at a plurality of locations on a surface of the volume.

9. The apparatus of claim 8, wherein the determining of the estimate of the magnitude of sound generated by the rotating tire further comprises aggregating a plurality of acoustic pressure values determined for each of the predefined angles of rotation of the rotating tire at a specified one of the locations on the surface of the volume.

10. The apparatus of claim 8, wherein the surface of the volume comprises a dome.

11. The apparatus of claim 1, wherein the volume around the rotating tire comprises a volume of a dome.

12. A method, comprising:
generating, via at least one processor circuit, a digital model of a rotating tire;
specifying a plurality of first cells of a first mesh within a tread of the rotating tire;
specifying a plurality of second cells of a second mesh in a volume around the rotating tire;
generating, via the at least one processor circuit, a plurality of air flow velocity vectors at a plurality of predefined angles of rotation of the rotating tire, where individual ones of the air flow velocity vectors are associated with a corresponding one of the first or second cells;
converting the air flow velocity vectors into corresponding ones of a plurality of Lighthill stress tensors;
generating, via the at least one processor circuit, an acoustic pressure at a plurality of points on a surface of the volume for each of the predefined angles of rotation of the rotating tire from the Lighthill stress tensors; and
determining, via the at least one processor circuit, an estimate of a magnitude of sound generated by a physical embodiment of the rotating tire from the acoustic pressure at a respective one of the points.

13. The method of claim 12, wherein the first mesh further comprises a Lagrangian mesh.

14. The method of claim 12, wherein the second mesh further comprises a Eulerian mesh.

15. The method of claim 12, wherein the generation of the plurality of air flow velocity vectors at the plurality of predefined angles of rotation of the rotating tire further comprises:
generating the plurality of air flow velocity vectors using an incompressible computational fluid dynamics subsystem; and
storing the plurality of air flow velocity vectors in a memory.

16. The method of claim 12, further comprising storing the digital model of the rotating tire in a memory.

17. The method of claim 12, wherein the volume further comprises a dome.

18. A non-transitory computer-readable medium embodying code executable by at least one processor circuit, wherein when executed the code causes the at least one processor circuit to at least:
generate a plurality of air flow velocity vectors at a plurality of predefined angles of rotation of a digital model of a rotating tire, where individual ones of the air flow velocity vectors are associated with a corresponding one of a plurality of first cells of a first mesh with a tread of the rotating tire or a corresponding one of a plurality of second cells of a second mesh in a volume around the rotating tire;
converting the air flow velocity vectors into corresponding ones of a plurality of Lighthill stress tensors;
generate an acoustic pressure at a plurality of points on a surface of the volume for each of the predefined angles of rotation of the rotating tire based on the Lighthill stress tensors; and
determine an estimate of a magnitude of sound generated by the rotating tire from the acoustic pressure at a respective one of the points.

19. The non-transitory computer-readable medium embodying code executable by the at least one processor circuit of claim 18, wherein the first mesh further comprises a Lagrangian mesh.

20. The non-transitory computer-readable medium embodying code executable by the at least one processor circuit of claim 18, wherein the second mesh further comprises a Eulerian mesh.

21. The non-transitory computer-readable medium embodying code executable by the at least one processor circuit of claim 18, wherein when executed the code further causes the at least one processor circuit to at least generate the digital model of the rotating tire.

22. The non-transitory computer-readable medium embodying code executable by the at least one processor circuit of claim 18, wherein when executed the code further causes the at least one processor circuit to at least specify the plurality of first cells of the first mesh within the tread of the rotating tire.

23. The non-transitory computer-readable medium embodying code executable by the at least one processor circuit of claim 18, wherein when executed the code further causes the at least one processor circuit to at least specify the plurality of second cells of the second mesh in the volume around the rotating tire.
